(19) United States
(12) Patent Application Publication
(10) Pub. No.: US 2008/0304841 A1
(43) Pub. Date: Dec. 11, 2008

(54) Virtual clean belt to enable direct sensing of toner quantity

(75) Inventors: Eric M. Gross, Rochester, NY (US); James P. Kitchen, Webster, NY (US)

Correspondence Address: FAY SHARPE / XEROX - ROCHESTER, 1100 SUPERIOR AVE., SUITE 700, CLEVELAND, OH, 44114, US

(73) Assignee: XEROX CORPORATION

(21) Appl. No.: 11/810,255

(22) Filed: Jun. 5, 2007

(51) Int. Cl. G03G 15/00

(52) U.S. Cl. 399/49

(57) ABSTRACT

In accordance with one aspect of the present exemplary embodiment, a system determines the amount of toner on a photo receptor in a xerographic operation. A photo receptor is charged in one or more locations to create an image. A developer places a patch of a predetermined amount of toner onto the one or more charge locations of the photo receptor. A light emitting diode projects light onto the photo receptor, wherein the intensity of the light varies based on the voltage provided to the LED. An optical reflective sensor measures the reflectance of the toner placed on the photo receptor, the amount of reflectance of the toner is related in a known way to the intensity of the LED.

### BACKGROUND

The following relates to toner density control in xerographic applications. It finds particular application in utilizing optical reflection to measure black toner density levels of solid patches placed on a clean belt. Application to other colors and to halftone levels, however, is not excluded.

In copying or printing systems such as a xerographic copier, laser printer or inkjet printer, a common technique for monitoring the quality of prints is to artificially create a test patch of a predetermined desired density. The actual density of the printing material, toner or ink for example, in the test patch can then be optically measured to determine the effectiveness of the printing process in placing this printing material on the print sheet.

In the case of xerographic devices such as a laser printer, the surface that is typically of most interest in determining the density of printing material thereon is the charge retentive surface or photoreceptor on which the electrostatic latent image is formed and subsequently developed by causing toner particles to adhere to areas thereof that are charged in a particular way. In such a case an optical device, often referred to as a densitometer, for determining the density of toner on the test patch is disposed along the path of the photoreceptor directly downstream of the development unit. There is typically a process within the operating system of the printer to periodically create test patches of the desired density at predetermined locations on the photoreceptor by deliberately causing the exposure system thereof to change or discharge as necessary the surface at the location to a predetermined extent.

The test patch is then moved past the developer unit and the toner particles within the developer unit are caused to adhere electrostatically. The denser the toner on the test patch, the darker the test patch will appear in optical testing. The developed test patch is moved past a densitometer disposed along the path of the photoreceptor and the light absorption of the test patch is tested. The density of toner on the patch varies in relationship to the percentage of light absorbed by the test patch.

Xerographic test patches that are used to measure the deposition of toner on paper to measure and control the tone reproduction curve (TRC) are traditionally printed on inter-document zones of photoreceptor belts or drums. Generally, each patch that is printed is a uniform solid halftone or background area. This practice enables the sensor to read values on the TRC.

Many xerographic printing system process controls move physical actuators such as developer bias, charge level and raster output scanner (ROS) intensity to maintain the TRC as measured by an in-line optical sensor. Optical reflective sensing of black solid patches at desirable densities can, in particular, suffer from a limited sensing range. Black toner has minimal diffuse reflection and specular reflection typically saturates near or below the developed mass per unit area (DMA) target level.

To overcome this difficulty, development curve measurement and projection schemes have been implemented (e.g., iGen3 patch generator approach) or high digital area coverage halftones that are somewhat correlated with solids have been used. The latter approach suffers to the extent that the correlation is poor, and the previous approach relies on extrapolation and has hardware overhead costs, software complexity, and bandwidth limitations.

In order to remedy this problem, alternative systems and methods need to be employed to more accurately determine patch density. Such identification can provide more consistent and accurate control over the quantity of toner, i.e. color, utilized for various applications.

### BRIEF DESCRIPTION

In one aspect, a system determines the amount of toner on a photo receptor in a xerographic operation. A photo receptor is charged in one or more locations to create an image. A developer places a patch of predetermined amount of toner onto the one or more charge locations of the photo receptor. A light emitting diode (LED) projects light onto the photo receptor, wherein the intensity of the light varies based on the voltage provided to the LED. An optical toner sensor with a saturation value measures the reflectance of the toner placed on the photo receptor, the amount of reflectance of the toner very well approximated as linearly related to the intensity of the LED.

In another aspect, a method is employed to measure the mass of toner on a photo receptor during a xerographic process. A patch of toner is placed on a photo receptor and a light is emitted onto the patch via an intensity of a light emitting diode (LED). The amount of light reflected off the patch is read as a specular voltage via an optical sensor.

In yet another aspect, a method is employed to measure the mass of toner in a xerographic process. A patch of toner is placed on a photo receptor belt in between two images. Light is emitted onto the patch via a predetermined intensity of a light emitting diode (LED). A relationship is determined between a specular reflectance of the patch and the intensity of the LED. The specular reflectance value of the patch is calculated based upon the intensity of the LED.

### BRIEF DESCRIPTION OF THE DRAWINGS

FIG. 1 illustrates a xerographic printing system, in accordance with an aspect of the present embodiment;

FIG. 2 illustrates a test patch and a photo receptor, in accordance with an aspect of the subject embodiment;

FIG. 3 illustrates a relationship between a specular voltage value and a mass of toner, in accordance with an aspect of the subject embodiment;

FIG. 4 illustrates a relationship between an LED intensity and a developed mass per area value, in accordance with an aspect of the subject embodiment; and

FIG. 5 illustrates a relationship between an LED intensity and a specular voltage value, in accordance with an aspect of the subject embodiment.

### DETAILED DESCRIPTION

It will become evident from the following discussion that embodiments of the present application set forth herein, are suited for use in a wide variety of printing and copying systems, and are not necessarily limited in application to the particular systems illustrated.

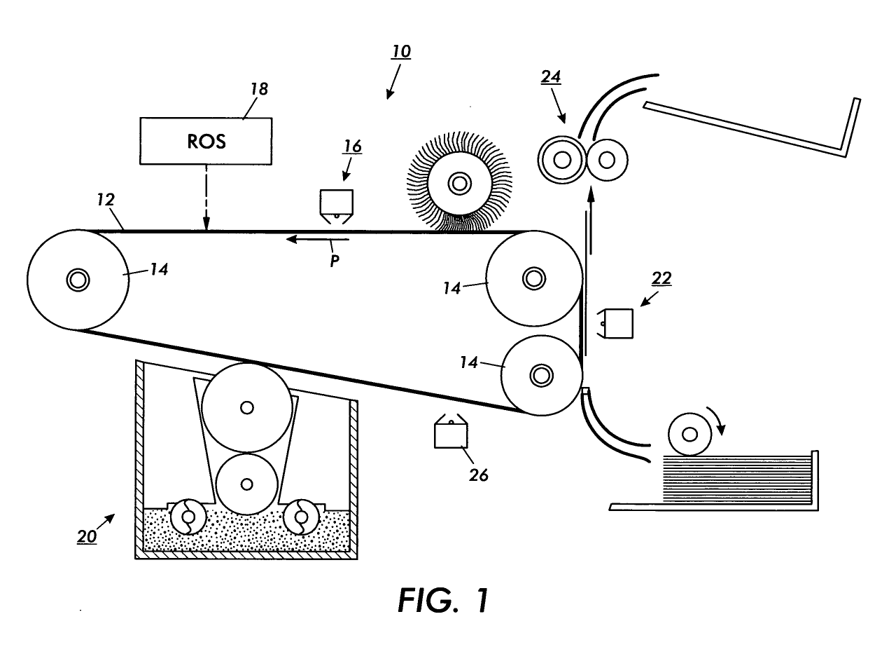

FIG. 1 is a schematic representation of a well-known system suitable for incorporating elements of the present embodiment. Included within printing electrophotographic system 10 is a photoreceptor 12 which may be in the form of a belt or drum and which comprises a charge retention surface. In this embodiment, photoreceptor 12 is entrained on a set of rollers 14 and caused to move in a counter-clockwise process direction by means such as a motor (not shown).

The first step in an electrophotographic process is the charging of the relevant photoreceptor surface. This initial charging is performed by charge source 16. The charged portions of the photoreceptor 12 are then selectively discharged in a configuration corresponding to the desired image to be printed by a raster output scanner (ROS) 18. ROS 18 generally comprises a laser source (not shown) and a rotatable mirror (also not shown) acting together in a manner known in the art to discharge certain areas of the charged photoreceptor 12. Although a laser source is shown in the exemplary embodiment, other systems that can be used for this purpose include, for example, an LED bar or a light lens system. The laser source is modulated in accordance with digital image data fed into it and the rotating mirror causes the modulated beam from the laser source to move in a fast scan direction perpendicular to the process direction of the photoreceptor 12. The laser source outputs a laser beam of sufficient power to charge or discharge the exposed surface on photoreceptor 12 in accordance with a specific machine design.

After selected areas of the photoreceptor 12 are discharged by the laser source, remaining charged areas are developed by developer unit 20 causing a supply of dry toner to contact the surface of photoreceptor 12. The developed image is then advanced by the motion of photoreceptor 12 to a transfer station including a transfer device 22, causing the toner adhering to the photoreceptor 12 to be electrically transferred to a substrate, which is typically a sheet of paper, to form the image thereon. The sheet of paper with the toner image thereon is then passed through a fuser 24, causing the toner to melt or fuse into the sheet of paper to create a permanent image. It is to be appreciated that toner can refer to substantially any color such as cyan, yellow, magenta and/or black.

In one approach, toner is placed directly on the surface of the photoreceptor 12 belt in the form of a patch. This patch can be comprised of a solid area of toner or a halftone. Toner placement can occur periodically such as between a particular number of sheets of paper, based on time, etc. An optical sensor 26 can measure the reflectance of the toner placed on the belt. This reflectance can correlate with one or more characteristics of the toner such as density, color, quality, etc. In one approach, the reflectance of the toner is related to developed mass per unit area.

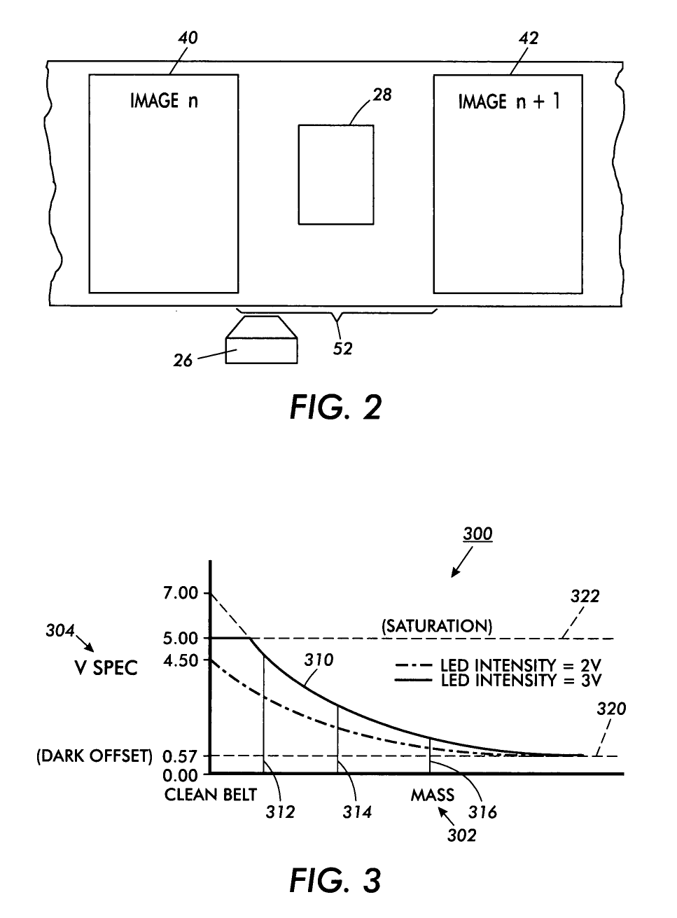

FIG. 2 illustrates a process method that uses the optical sensor 26 to monitor the reflectance of a patch 28 placed on the photoreceptor 12 in between a first document 40 and a second document 42. The sensor 26 monitors the reflectance of the patch 28 (e.g., a black solid patch in this specific example) placed in the inter-document zone 52 of the photoreceptor 12. It is to be appreciated that the arrangement of the patch 28 and the sensor 26 is provided as an aid to understanding concepts of the present embodiment. Other arrangements of patches (e.g., more than one patch), with one or more sensors, are envisioned and fall within the scope of the present embodiment.

In operation of the sensor 26, collimated light rays are projected onto the photoreceptor 12 which includes the patch 28. The light rays reflected from the patch 28 are collected and directed onto a photodiode array (not shown). The photodiode array generates electrical signals proportional to the total flux and a diffuse component of the total flux of the reflected light rays. The ETAC sensor 26 thus measures the amount of filming on the photoreceptor after the cleaning station using reflected infrared light. In one embodiment, the electrical signal output of the ETAC sensor 26 is in terms of voltage.

In one approach, the linear clean belt response to sensor LED intensity is employed to project to a clean belt read beyond a saturation point. The saturation point can be described as the maximum level of light reflectance that can be read by the ETAC sensor 26. Once the saturation point is reached, an increase in the amount of light will not result in a change of the signal output of the sensor 26. For this reason, under conventional systems, the sensor could only provide useful information when the light reflectance was at or below the saturation point.

In contrast, and as described herein, the output of the sensor 26 can be determined based on a known relationship between the light intensity and corresponding electrical output of the sensor 26. In one example, the relationship between light intensity and sensor output is linear. In another example, such a relationship is described by a polynomial. Utilizing such a known relationship, a second value (e.g., light intensity) can be calculated based on a known first value. It is to be appreciated that substantially any relationship can be identified.

The projected clean belt read can be utilized to determine the relative reflectance for the solid area of the patch 28. It is known that the relative reflectance (the ratio of specular response to the specular clean belt response) is correlated with DMA. In computing the relative reflectance, sensor to sensor and photoreceptor to photoreceptor differences are compensated. Thus, the constraint of maintaining the clean belt read within the sensing range of the device is broken to permit wider latitude in setting the LED intensity to optimize the sensing range as a function of the patch 28 density.

FIG. 3 illustrates a relationship 300 between developed mass 302 on the photoreceptor 12 and the specular voltage reading (Vspec) 304 from the Extended Toner Area Coverage (ETAC) sensor 26. The bare photoreceptor 12 (e.g., clean belt) gives a maximum reflectance of specular light, which is known as the clean belt read. As more toner is developed, it either absorbs the incident light or scatters it as diffuse light. Both of these decrease the amount of specular light that is reflected back to the sensor 26. For solid patches at sufficiently high masses (typically at or below the target DMA), the specular ETAC reading is a non-zero value known as the dark offset, the output of the sensor when no light is detected. To first order, this is the minimum reading for the sensor 26; the same reading occurs when the LED light is turned off.

For higher LED intensities, the specular response to mass curve shifts up, as illustrated by solid curve 310. This higher intensity gives several benefits that allow for solid patches to be measured from the specular sensor reading. First, for a constant mass 312, 314, or 316, the signal is further away from the dark offset value, leading to greater sensing range at high masses. Such a signal will lead to the ability to control at higher masses. Second, for any constant specular sensor reading 320 or 322, higher intensities correspond to higher masses on the photoreceptor 12. Therefore, controlling the process to the same specular voltage target with a higher LED intensity will yield a greater mass.

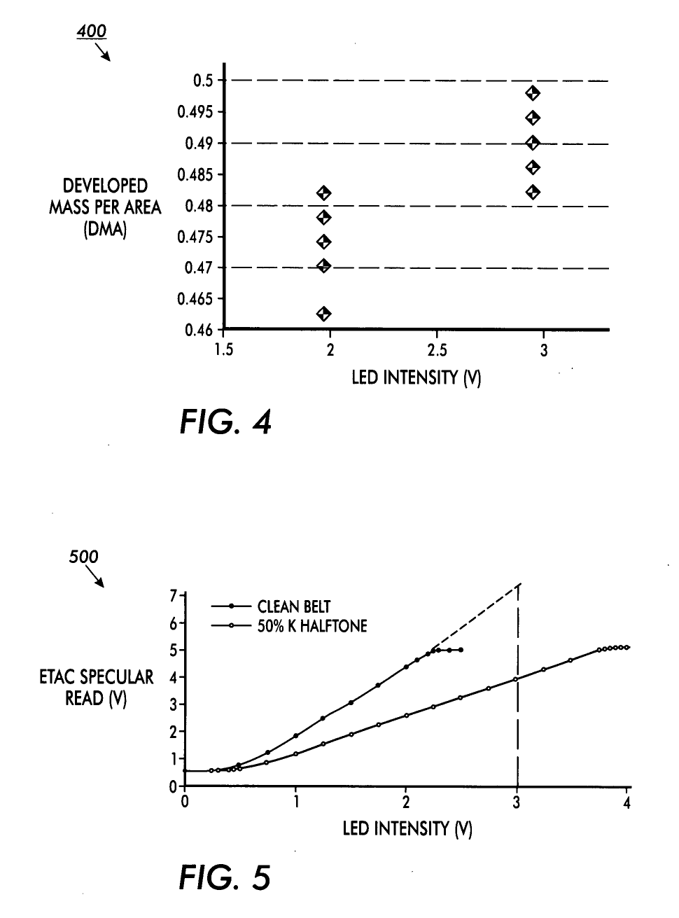

FIG. 4 is a graph 400 that illustrates an increase in DMA due to a higher LED intensity. To demonstrate that higher LED intensities do, in fact, increase the mass, several prints were run on an iGen machine at the machine LED intensity setting of around 2 Volts. Next, the LED intensity was increased to roughly 3 Volts. The transmission density was measured for the prints and then converted to DMA.

One challenge to increasing LED intensity to desirable levels is that the specular clean belt reads saturate at a value of 5 Volts. Any clean belt readings above this threshold will be indistinguishable. It is important to note that increasing the LED intensity will still yield higher masses. However, without an accurate clean belt read to compensate for sensor to sensor and photoreceptor to photoreceptor differences, the mass density control will be inaccurate. The traditional way to deal with this is to target a clean belt reading that is below the saturation threshold (e.g., between 4.3 and 4.6 volts). Unfortunately, this does not give adequate range for developing solids at the desired mass target.

The solution to this issue is to construct a virtual clean belt read from clean belt readings at lower LED intensities. These clean belt readings have a reasonably assumed linear relationship 500 (between the dark offset and upper saturation limit) with LED intensity, as shown in FIG. 5. The relationship of LED intensity to light output is also shown to be linear for a fifty percent black halftone patch. Such a linear correlation can be extrapolated at LED intensities greater than the values normally applied. As shown, the linear relationship holds well beyond 3V of intensity in the fifty percent half tone curve. It is to be appreciated, however, that substantially any identifiable relationship can be employed. For example, a relationship between two metrics that is described by a particular function (e.g., sinusoid, polynomial, etc.) can be extrapolated to increase the measurement range to include higher DMA levels.

In this manner, the LED intensity can be increased to levels beyond a saturation point (e.g., 5V) to provide a virtual clean belt reading. As illustrated, as the LED intensity is increased from approximately 2.25V to 3V, a virtual clean belt reading that corresponds linearly can be identified. In one example, when the LED intensity is increased to 3V, a virtual clean belt reading of 7V is recognized. This reading is higher than the 5V maximum read utilizing conventional measurement techniques. In contrast, this measurement technique disclosed herein can eliminate the need for the additional hardware necessary in the iGen architecture to control black solids and can allow current sensors to measure black solids, which they previously were unable to do.

Because there is a linear relationship, the clean belt curve can be extrapolated beyond the point of saturation to find the LED intensities corresponding to higher clean belt specular voltage readings. Using these higher LED operating intensities would not be functional for light patches (the sensor would still saturate until a sufficient mass is rendered), but would extend the measurement capability of higher DMA levels. As an example of implementation, the iGen3 architecture currently allows for toggling the LED intensity between different levels depending on the patch being measured, allowing a lower LED intensity to be used to measure low and mid-patches, and a higher LED intensity to be used to measure solid patches.

In summary, the innovation described herein extends the range of useable LED intensities beyond what would normally saturate the specular sensor by using a virtual clean belt reading, thereby allowing solid patches to be effectively measured and controlled with the specular ETAC sensor. Without the virtual clean belt reading, the LED intensities do not provide enough range to adequately measure and control solid patches to requisite mass levels. In this manner, finisher costs associated with a xerographic process can be reduced. Further, a lower number of components that employed utilizing conventional means can be realized.

It will be appreciated that variations of the above-disclosed and other features and functions, or alternatives thereof, may be desirably combined into many other different systems or applications. Various and variant embodiments presently unforeseen or unanticipated alternatives, modifications, variations or improvements therein may be subsequently made by those skilled in the art which are also intended to be encompassed by the following claims. In addition, the claims can encompass embodiments in hardware, software, or a combination thereof.

1. A system that determines the amount of toner on a photoreceptor in a xerographic operation, comprising:
a photoreceptor that is charged in one or more locations to create an image;
a developer that places a patch of a predetermined amount of toner onto the one or more charged locations of the photoreceptor;
a light emitting diode (LED) that projects light onto the photoreceptor, wherein the intensity of the light varies based on voltage provided to the LED; and
an optical reflective sensor with a saturation value that measures the reflectance of the toner placed on the photoreceptor, the amount of reflectance of the toner is linearly related to the intensity of the LED.

2. The system according to claim 1, wherein the reflectance of the toner is quantified as a specular read voltage.

3. The system according to claim 1, wherein the specular read voltage of a tonerless belt patch is calculated via extrapolation of the linear relationship based on the intensity of the LED.

4. The system according to claim 3, wherein the calculation is performed only when the sensor is at or above the saturation value.

5. The system according to claim 1, wherein the intensity of the light projected by the LED correlates to at least one of a density, a mass, and a color of the toner.

6. The system according to claim 1, wherein the LED intensity is correlated in a known way to the developed mass per area of the toner in a predetermined via a predetermined relationship.

7. The system according to claim 6, wherein a greater LED intensity is related to a greater developed mass per area of toner.

8. The system according to claim 2, wherein the relationship between the LED intensity and the specular read voltage is one of first order, second order and third order.

9. The system according to claim 1, wherein the patch is a solid or halftone.

10. The system according to claim 9, wherein the specular read voltage is related to the toner color of the patch.

11. A method for measuring the mass of toner on a photoreceptor during a xerographic process, comprising:
placing a patch of toner on a photoreceptor;
emitting a light onto the patch via an intensity of a light emitting diode (LED)
reading the amount of light reflected off the patch as a specular voltage via an optical reflective sensor;
determining if the specular voltage exceeds a predetermined saturation point; and
calculating the specular voltage value based upon a known relationship between the specular voltage and the LED intensity if the specular voltage exceeds the predetermined saturation point.

12. The method according to claim 11, wherein the patch of toner is placed between two substrates, the substrates are at least one of a velum, a paper and an acetate.

13. The system according to claim 11, wherein the calculation is performed only when the sensor is at or above the saturation value.

14. The method according to claim 11, wherein the intensity of the LED is varied by changing a voltage level provided to the LED.

15. The method according to claim 11, wherein the relationship between the specular voltage and the LED intensity is linear.

16. The method according to claim 11, wherein the mass of the toner patch is related to the value of the specular voltage value.

17. The system according to claim 11, wherein the specular read voltage is related to the toner color of the patch.

18. A method that measures the mass of toner in a xerographic process, comprising:
placing a patch of toner on a photoreceptor belt in between two sheets of paper;
emitting light onto the patch via a predetermined intensity of a light emitting diode (LED);
determining a relationship between a specular reflectance of the patch and the intensity of the LED; and
calculating the specular reflectance value of the patch based upon the intensity of the LED.

19. The method according to claim 18, wherein the relationship between the specular reflectance of the patch and the intensity of the LED is linear.

20. The method according to claim 18, wherein the mass of the toner patch is related to the value of the specular voltage value.
